(19) United States
(12) Patent Application Publication
(10) Pub. No.: US 2002/0088068 A1
(43) Pub. Date: Jul. 11, 2002

(54) Wear sensor device and method

(76) Inventors: David H. Levy, Cambridge, MA (US); Daniel S. Coriat, West Roxbury, MA (US)

Correspondence Address: Arthur D. Enterprises, Inc., Acorn park, Cambridge, MA, 02140, US

(21) Appl. No.: 09/736,580

(22) Filed: Dec. 15, 2000

Related U.S. Application Data
(60) Provisional application No. 60/170,897, filed on Dec. 15, 1999.

(51) Int. Cl. A61C 17/22

(52) U.S. Cl. 15/22.1

(57) ABSTRACT

A vibrating toothbrush having an indicator which changes in response to vibration is arranged to provide an indication directly related to the cumulative duration of the vibrations.

### RELATED APPLICATIONS

This application relies for priority upon U.S. Provisional Application No. 60/170,897 filed Dec. 15, 1999, now abandoned.

### FIELD OF THE INVENTION

This invention relates to a vibrating toothbrush of the type having a brush which is replaced after an appropriate period of use.

### PRIOR ART

Vibrating toothbrushes are disclosed in U.S. Pat. Nos. 5,305,492, 5,263,218, 4,991,249 and 5,138,733.

### SUMMARY OF THE INVENTION

An apparatus arranged to provide an indication of duration of vibrations produced in a device comprises indicator means coupled to the device to continually change in response to the vibrations to provide an indication directly related to the cumulative duration of the vibrations. By way of example, wear of the brush of a vibrating toothbrush is measured directly from toothbrush operation by coupling the oscillation of a beam structure which holds the brush to a device which uses the motion of the surface of the beam parallel with the plane of oscillation to drive an abrasive or cutting structure that wears away at a material. In addition, the motion of the surface of the beam perpendicular to the plane of oscillation is used to strike a resonator. The wear material is arranged to isolate the resonator from contact with the beam for a predetermined time. Such an arrangement may be dictated by the force of abrader against the material, and the type of abrader and wear material selected. In the preferred embodiment, a displacement beam applies a force to the wear material arranged to have a resonator at its free end. An abrader is disposed at a location on the toothbrush mechanism that oscillates at a known and relatively high amplitude, such as the extreme end of the aforementioned beam structure. As the toothbrush is used, the abrader wears at the wear material causing the free end of the displacement beam to approach the beam structure. More significantly, this motion causes the resonator supported by the displacement beam to approach the surface of the beam structure that lies perpendicular to the plane of oscillation.

In the preferred embodiment, these structures are canted relative to each other such that the resonator approaches the beam structure at a 45 degree angle or less, relative to the plane of oscillation. This provides a gradually increasing acoustic signal, beginning with a non-irritating hum and increasing to an annoying buzz as the device continues to operate. In order to provide the necessary volume of sound through the housing of the toothbrush resonator is disposed at the end of another more flexible beam, that extends from the free end of the displacement beam. The design parameters are filled so that the hum correlates with warning the user that the brush is beginning to wear and the annoying buzz correlates with the need to replace the brush. Time correlation may be tuned by varying the crossectional area of the abrader, so that more or less material must be abraded before the resonator may advance.

In an embodiment of the invention that provides visual feedback, a dial that is free to rotate is in face-to face contact with the interior of the product housing. A visual indicia can be seen through a clear window located in the region of contact. A texture, disposed on the contact surfaces, has a directional bias, not unlike the scales of a fish, to provide the dial a preferential direction of rotation. A spring at the back of the dial presses it against the product housing with a known force. As the product is used, the vibrations are transmitted to the dial, causing microscopic force imbalances to result in a rotary motion over time whose rate is a function of the spring force, texture, and dial mass. This invention therefore provides an extremely simple and low cost way to indicate the amount of time that a product (with a characteristic oscillation frequency) has been in operation. This indicator may be manufactured in the product, or may be adhered at any time as an aftermarket device. By tuning these devices, they may operate at a wide variety of frequencies, thereby providing timers to monitor the amount of time spent in different modes of operation.

### BRIEF DESCRIPTION OF DRAWINGS

FIG. 1 shows an assembly drawing of a vibrating toothbrush, revealing a wear sensing device within.

FIG. 2 shows a cross-sectional view of the wear sensing device shown in FIG. 1.

FIG. 3 shows a cross-sectional view of a wear sensing device that provides a visual indication of wear.

FIG. 4 shows a plan view of a dial with visual indicia and biased texture.

### DETAILED DESCRIPTION

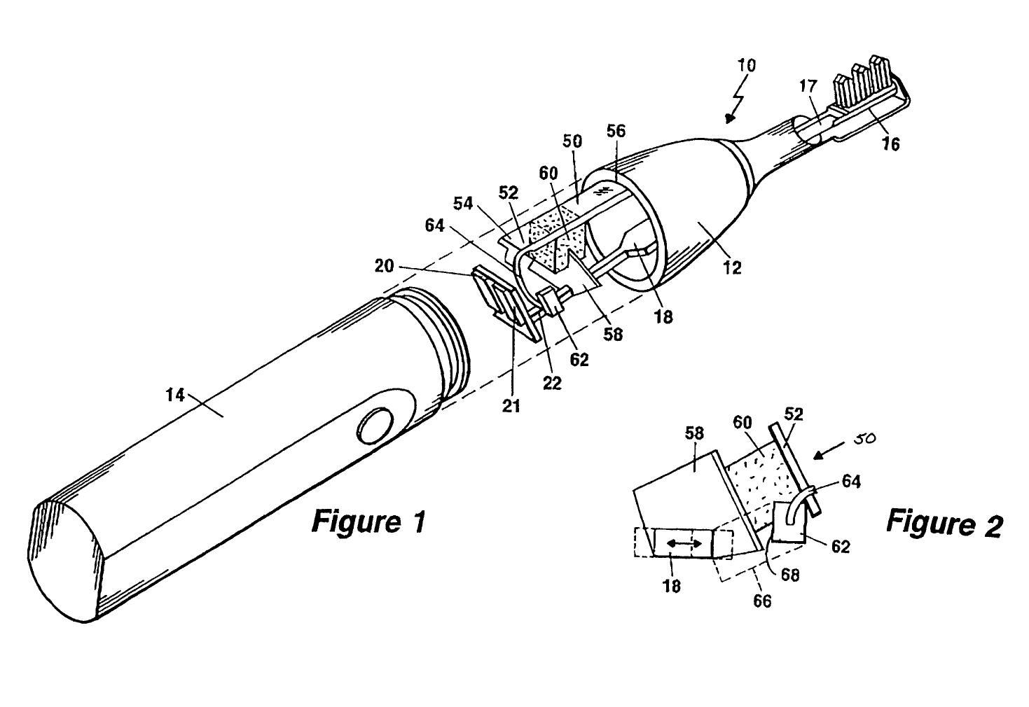

FIG. 1 shows a perspective view of a vibrating toothbrush 10 with the head 12 unscrewed from the base 14, exposing vibration-sensing device 50. After toothbrush 10 operates for a predetermined duration, a subtle, non-annoying sound begins and slowly grows into a noticeable and somewhat annoying noise, an indication directly related to the cumulative duration of the vibrations produced in toothbrush 10 and an indication that it is time to replace brush 16. Many devices have a vibration inherent to their operation, such as the vibrative toothbrush 10 shown here and further described in U.S. Pat. No. 5,189,751. In this device, brush 16 is mounted to a first end 17 of rigid beam 18 with permanent magnets 20, 21 mounted at the second end 22 of rigid beam 18 and positioned side by side with opposite polarities. Rigid beam 18 is pivotally attached to head 12 at a point approximately equidistant between brush 16 and magnets 20. An alternating current driving signal from an oscillator/battery section (not shown) mounted in base 14 causes an electromagnet (not shown) also mounted in base 14 to move end 22 of the rigid beam 18 about the pivot point, first in one direction and then in an opposing direction to produce the desired vibrating effect and, in turn, an approximately equal side-to-side motion in brush 16.

Vibration sensing device 50 is integrally assembled into toothbrush 10 as follows: displacement beam 52 has a free end 54 and a fixed end 56. Fixed end 56 is rigidly attached inside head 12. Displacement beam 52 roughly parallels rigid beam 18 with free end 54 terminating proximate the magnets 20, 21. Abrader 58 (shown here as a knife edge) is permanently attached to rigid beam Abrader 58 may provide one-dimensional abrasion, as shown here, or two-dimensional abrasion such as would be provided by stamping a plurality of small ridges into rigid beam 18, forming an abrasive surface. In either embodiment, free end 54 is held from contact with abrader 58 by wear material 60. Displacement beam 52 is in flexure such that free end 54 applies a force to abrader 58 through wear material 60. Resonator 62 is mounted to free end 54 through flexible beam 64. In the preferred embodiment, abrader 58, wear material 60, resonator 62, flexible beam 64 and displacement beam 52 are all slanted at an angle of approximately 45 degrees with respect to the plane defined by the direction of oscillation of rigid beam 18 as shown in FIG. 2.

FIG. 2 shows a cross-sectional drawing that is useful to describe operation of the preferred embodiment of a vibration sensing device 50 that provides an audible signal to indicate duration of vibratory operation and associated wear of brush 16. Operation is as follows: as manufactured there is no wear in wear material 60. Therefore, free end 54 is maximally distant from second end 22 and resonator 62 is above the plane of oscillation traversed by rigid beam 18 and, due to the 45 degree angle, it is also displaced to the right of rigid beam 18. No detectable sound is heard. The oscillation of rigid beam 18, coupled with the force applied by the displacement beam 52 causes abrader 58 to wear and/or abrade material from wear material 60 at a predictable rate. As wear material 60 is worn away, resonator 62 follows the path shown by dotted lines 66. At some point an extreme edge 68 of resonator 62 begins to enter the oscillatory path traversed by rigid beam 18, causing rigid beam 18 to strike resonator 62 with minimal force to produce a slight humming sound. This correlates with warning the user that the brush is beginning to wear. As vibrating toothbrush 10 continues to be used, wear material 60 continues to wear away and resonator 62 is increasingly placed deeper into the oscillatory path of rigid beam 18 causing rigid beam 18 to strike resonator 62 with greater force to produce a slow and progressive increase in the sound, ultimately resulting in an annoying buzz that informs the user to the brush should be replaced. The housing of the vibrating toothbrush 10 might muffle the sound volume if beam 64 would be relatively rigid. In the preferred embodiment, beam 64 is flexible so that a minimally sized resonator 62 will move away from rigid beam 18 when struck by rigid beam 18 to produce a desired volume of sound.

The rate of wear of brush 16 is determined by the amplitude and frequency of the oscillation of beam 18 the material and geometry of abrader 58, the material selected for wear material 60 and the force applied against the wear material 60 by displacement beam 52. The wear sensing device 50 is a robust and low cost device that is independent of moisture content or shelf life.

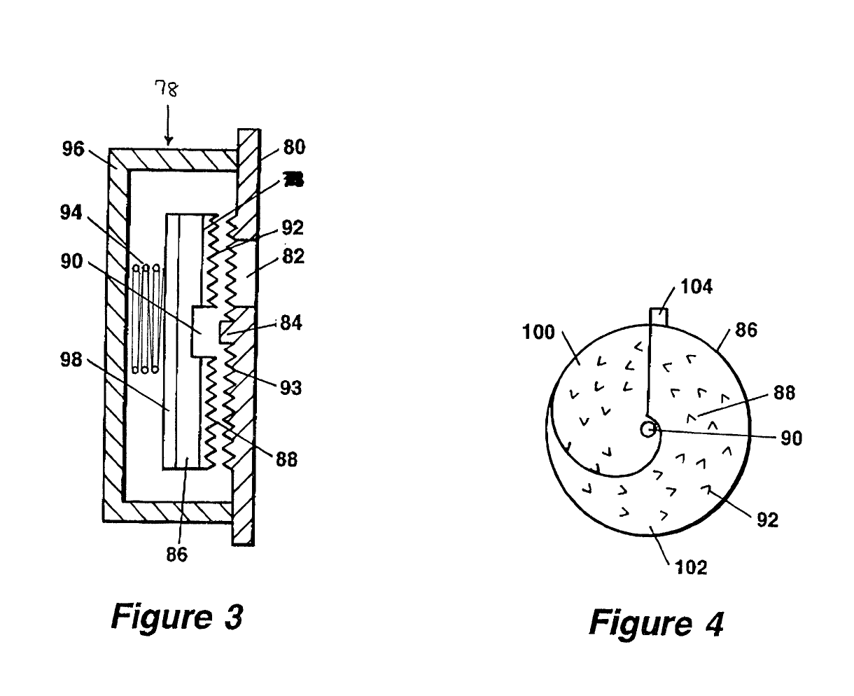

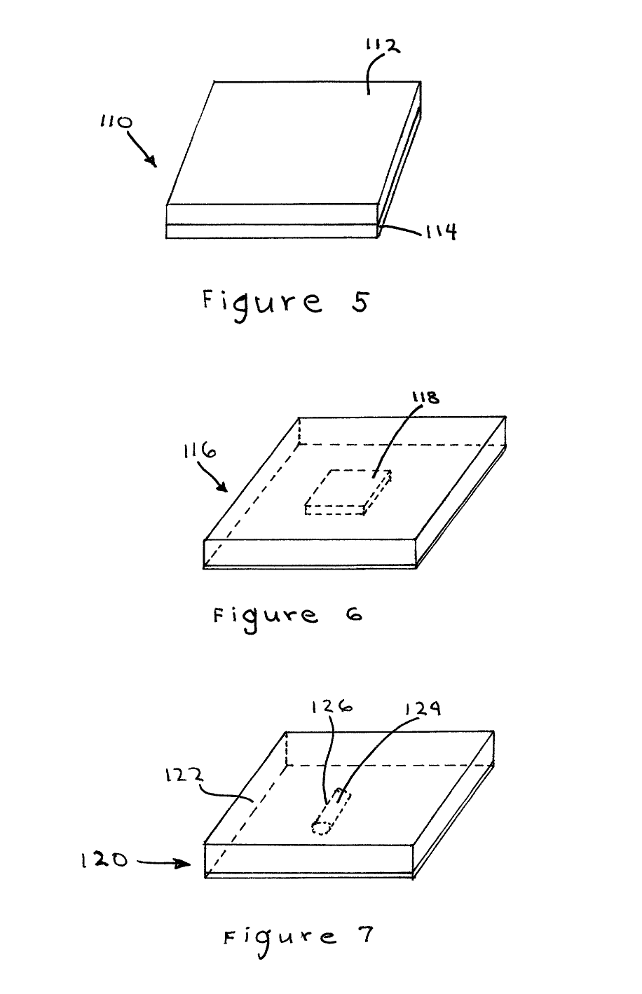

FIG. 3 shows a cross-sectional view of a vibration sensing device 78 arranged to provide a visual indication of the cumulative duration of vibrations and related wear of brush 16. The vibration sensing device 78 may be assembled into the head 12 of toothbrush 10 so as to move in response to vibration produced by the alternating driving signal from an oscillator/battery section (not shown) mounted in base 14. The wear sensing device 78 has window 82 and orientation feature 84. Dial 86 has visual indicia 88 with a biased texture 92 facing window 82 and a mating orientation feature 90. Operation is provided by biased texture 93 disposed onto the internal areas of surface and the biased texture 92 on dial 86 which contact each other. Biased texture 92 and 93 consists of a multitude of tiny protrusions, not unlike the scales of a fish, that provide a uniform directionality to the surface texture, as shown in FIG. 4. This texture may be provided by a stamping process. Spring 94 applies a constant known force to the face of dial 86, providing a manufacturer-definable normal force between product housing 80 and dial 86. Backing 96 supports the face of spring 94 and seals vibration sensing device 78 from moisture and/or particulate contamination. (Note that bias texture 92 may be omitted from either the product housing 80 or the dial 86 if the individual features which comprise bias texture 92 are designed with geometry to provide a force beyond that provided by frictional forces.)

As the vibrations of toothbrush 10 are transmitted through the wear sensing device 78, the mass of dial 86 creates deformation and displacement in biased texture 92. The asymmetric orientation of the protrusions 92 result in a predictable tendency towards rotation of dial 86 in one direction. As drawn in FIG. 4, dial 86 would rotate clockwise. The rate of rotation is a function of the strength of spring 94, the geometry and material of biased texture 92, and the mass of dial 86. An additional mass 98 may also be used to amplify the transmission of vibrational energy into vibration sensing device 78 while maintaining a minimal overall size and increasing the allowable manufacturing tolerance of biased texture 92. FIG. 4 also shows an example of the visual indicia 88. As manufactured, a green region 100 is displayed through window 82. With use, dial 86 continually rotates clockwise and red region 109 becomes more prominently displayed. Eventually, only the color red will show through the window 82, at which time post 104 will strike an associated feature on vibration sensing device 78, preventing further rotation and an indication that the brush 16 is worn to the point of replacement.

Another indicator of duration of vibration is an indicia which changes appearance over use of a vibrating toothbrush. This change can be in the form of a visual change in appearance of the brush, an audible sound, or a taste/odor release after a predetermined duration of vibration. All these forms of indicators react to vibrations and over time the desired reaction takes place thus informing the user that it is about time to discard the brush. The indicator is preferably a glued or heat-fused “patch” or other appendix, allowing its attachment to a vibrating portion of the toothbrush with minimal disruption during assembly. Alternatively, the indicator can be molded into a convenient section of the head.

Referring to FIG. 5, there is shown a prospective view of an appendix 110 preferably made of a material 112 deposited on an adhesive-backed layer 114. The material 112 changes its physical properties when subjected to vibrational energy, breaking up or getting loose and/or dissolved after a predetermined, cumulative timeframe. Examples of materials that follow this behavior are generally brittle in nature and include crystallized sol-gels, compacted powders, plastics, etc. A broad range of polymer substances that erode and react under vibrational energy are disclosed in U.S. Pat. Nos.: 4,779,806; 5,562,099; and 4,948,587. After a predetermined timeframe, the material 114 breaks up or simply goes away.

Referring to FIG. 6, there is shown an embodiment of a hollow 116, sound 14. based indicator in the form of an appendix or “cage” attached to the toothbrush with at least one internal member 118 provisionally glued to the inside of the cage 116. Over use, the glue will lose its adhesive properties, allowing the internal member 118 to rattle inside the cage 116 after a predetermined timeframe.

Referring to FIG. 7, there is shown an embodiment of a taste/odor-based indicator 120 in the form of an appendix 122 containing a substance 124 provisionally contained by a membrane 124 inside a capsule or microsphere 126. Over use, the membrane weakens and cracks and the substance is released (examples of controlled release membrane formations sensitive to ultrasound are disclosed in U.S. Pat. Nos. 4,898,734 and 5,814,599.) Alternatively, the microsphere can contain a dye which is released after a predetermined timeframe, indicating a change in visual appearance.

In another embodiment, head 12 includes an identification means that may be read by a microprocessor disposed within base 14 or a battery charging unit. One such means for effecting this identification is through conductive tabs that are read by the base 14 when connected to brush 16. Through the identification means and by performing a simple timing operation the microprocessor monitors usage of each of a plurality of heads as they are used with a common base 14 and/or a common charging unit. When the microprocessor detects that a given brush 16 has been used sufficiently to be replaced, the user is notified by an audio signal or visually on a liquid crystal display. The same system may be used to monitor and report the brushing patterns and habits of each member of a family, a useful hygiene training tool for parents to use with their children.

Another arrangement for accomplishing the desired end result is to locate in the head unit a circuit which includes a light source which impinges on a light sensor coupled to a counting circuit. The path of the light from source to sensor is arranged to be broken by the vibrating beam so that the circuit counts the number of vibrations. Upon a pre-selected count being recorded, an audible or visual signal is generated which is perceptible by the user of the toothbrush.

Design choices of the indicator must take into account the effective life of the replaceable head. Design parameters can be fine-tuned during an iterative development effort, in order to determine the optimum choice of material, its thickness, compactness, or other specification so the reaction occurs during the desired window of usage.

What is claimed is:

1. Apparatus for providing an indication of duration of vibrations produced in a device comprising:
indicator means coupled to said device to continually change in response to said vibrations to provide an indication directly related to the cumulative duration of said vibrations.
A toothbrush system comprising:
a base unit for generating an alternating magnetic field:
a head unit adapted for mounting by hand on said base unit including a toothbrush located near one end of the base unit and a magnet near the other end, the magnet being mechanically linked to the toothbrush, the magnet being located in the alternating field when the head unit is mounted on the base unit so as to vibrate said toothbrush; and
an indicator on said head unit which continually changes in response to said vibrations to generate a signal perceptible to the user of said system that the head unit should be replaced.
